(19) United States
(12) Patent Application Publication
(10) Pub. No.: US 2023/0046511 A1
(43) Pub. Date: Feb. 16, 2023

(54) METHOD AND SYSTEM FOR TRANSMITTING AND REPRODUCING ACOUSTIC INFORMATION

(71) Applicant: M.U. MOVIE UNITED GMBH, Innsbruck (AT)

(72) Inventors: Albert-Tobias HAMMERSTINGL, Dornbirn (AT); Carmen SOMMER, Innsbruck (AT); Robert WOLF, Innsbruck (AT); Michael ROMANOV, Graz (AT)

(73) Assignee: M.U. MOVIE UNITED GMBH, Innsbruck (AT)

(21) Appl. No.: 17/785,696

(22) PCT Filed: Dec. 15, 2020
(86) PCT No.: PCT/EP2020/086137

§ 371 Date: Jun. 15, 2022

(30) Foreign Application Priority Data
Dec. 16, 2019 (EP) 19216412.7

(51) Int. Cl. H04N 21/436; H04N 21/439; H04N 21/485

(52) U.S. Cl. CPC H04N 21/43615; H04N 21/439; H04N 21/4852

(57) ABSTRACT

In a method for transmitting and reproducing acoustic information, acoustic data is provided which comprises a first data component and a second data component, wherein the first data component does not contain speech information, and the second data component contains speech information. Each piece of data is reproduced by first and second audio reproduction means (30, 40) such that all users (101, 102) can hear the acoustic signals emitted by the first audio reproduction means (30) together, and the acoustic signals emitted by the second audio reproduction means (40) can be heard substantially only by the corresponding user (101, 102).

The present invention relates to a method and a system for transmitting and playing back acoustic information. In particular, the invention relates to a method and a system used as part of a multimedia application, for example when playing back a movie.

Movies are usually played back as part of cinema presentations in relatively large spaces or possibly even outdoors in such a manner that the video image is displayed on a projection screen which is visible to all viewers, on an LED wall, by virtual reality or the like, and the sound, that is to say the acoustic information belonging to the video image, is played back via a central loudspeaker system, that is to say a loudspeaker system which can be jointly heard by all viewers. All viewers therefore hear the identical acoustic information in this case, which means, in particular, that, in the case of dialogs or generally speech information, it/they is/are fundamentally perceived in the identical language by all observers.

However, there is increasingly the desire or need to make it possible for the viewers, as part of a movie presentation, to flexibly individually provide the movie in a desired language. That is to say, different viewers should ideally be able to watch the movie at the same time, but to nevertheless follow it in each case in a language desired by the viewers. This makes it necessary to transmit individually adapted acoustic information to each of the viewers.

An obvious and already known solution to this problem is for each viewer to wear headphones, wherein the acoustic signal then contains the speech information contained therein in the language desired by the viewer according to the viewer's wish and is played back through the headphones. Since there are generally versions of a movie which are synchronized in different languages, that version which corresponds to the listener's desired language is then transmitted in this case to the listener—usually via cellphones with appropriate apps (for example myLINGO, Native Waves, SoundFi . . . ), wherein the listener can then perceive this version directly via their headphones. It would then be possible to dispense with centrally playing back the acoustic information with the aid of a central loudspeaker system since each viewer hears or perceives the acoustic information exclusively via the headphones in any case. However, in reality, the movie is usually centrally played back in one language, wherein viewers wishing to follow the movie in a differing language individually receive it, with all further associated sound information, via the above-mentioned apps or similar additional devices.

However, it has been found that the variant described above leads to an unsatisfactory result. The problem in this respect is initially the fact that the spatial perception of the acoustic information during a conventional cinema show can only be inadequately achieved with the aid of the headphones. In particular, there is the problem, however, that each viewer perceives the acoustic information in complete isolation from other viewers, which contradicts the aim usually strived for with a visit to the cinema, specifically watching a movie together. In the variant which is likewise described and in which the movie is centrally played back in one language and differing languages are individually provided by an app or the like, echoes or the problem of so-called double sonication may also arise because the identical audio information—with the exception of the different languages—of a movie is played back by loudspeakers and headphones, which in turn has a disruptive effect on the listening experience.

EP 1 427 253 A2 describes a multichannel audio system which provides for a listening area to be subdivided into a plurality of so-called listening spaces, wherein a cinema auditorium having a plurality of cinema seats is described as the listening area, for example, and the individual listening spaces are formed at the respective cinema seats. Specifically, it is proposed to equip the cinema seats with a plurality of loudspeakers which are arranged in the head region of the seated user. The described system provides for two categories of loudspeaker groups to be used, wherein a central loudspeaker group provides the entire listening area with audio signals and other loudspeaker groups each individually output audio signals in the respective listening space. In this case, it is significant that EP 1 427 253 A2 aims for each individual user, irrespective of their position in the listening area, that is to say irrespective of the sitting position in the cinema auditorium for example, to have exactly the same audio experience. The signals emitted via the individual loudspeaker groups differ from listening space to listening space since the audio signals emitted via the central loudspeaker group can be perceived differently at the different listening space positions, which is accordingly compensated for with the aid of the audio signals emitted via the respective individual loudspeaker group. The audio information output via the central loudspeaker group is therefore additionally also output by the individual loudspeaker groups, but is adapted in each case in such a manner that the overall result is an identical perceptual experience. Therefore, irrespective of their sitting position, all users of the system perceive the incoming audio signals overall as if they were all sitting centrally in front of the projection screen in the cinema auditorium, for example. EP 1 427 253 A2 therefore describes a multichannel audio system in which a plurality of users at different positions in a listening area are always intended to have the same audio experience, with the result that the sitting position in a cinema auditorium, for example, is no longer relevant to the audio experience since the perception of the audio signals by the individual user is identical anyway. In this case, in particular, audio signals which are emitted via the central loudspeaker group are always also emitted, in an individually influenced manner, via all loudspeakers in the individual loudspeaker groups, wherein the spatial and position dependency of the acoustic perception is eliminated by means of destructive superimposition of the various audio signals.

However, such an audio system does not allow the user to have an optimum, in particular acoustically plausible, listening experience since the audio signals perceived by the user do not represent the spatial audio characteristics on account of the individual compensation sonication by the respective loudspeakers in the individual loudspeaker group. Depending on the actual position of the viewer, a listening experience which does not match the visual perception of the viewer may therefore arise here. Furthermore, the method described in the prior art is a very complex form of transmission of the audio signals since the audio information emitted via the central loudspeaker group must be additionally also emitted via the local loudspeaker groups.

Therefore, the present invention is based on the object of specifying a possible way of optimizing the playback of acoustic information in such a manner that the perception by a user is improved further. In particular, the intention is to enable a joint, spatially natural and acoustically plausible surround sound experience.

The object is achieved by means of a method for transmitting and playing back acoustic information as claimed in claim 1 and by means of a system as claimed in claim 11. The dependent claims relate to advantageous developments of the invention.

In contrast to the above-described solution which is known from the prior art and in which the acoustic information is always transmitted to a viewer in a single specific way, the invention proposes using two separate ways of transmission for the transmission in such a manner that the acoustic information is transmitted in a manner split between both ways, but in such a manner that the information can then ultimately be perceived by a user, that is to say a viewer or a listener, in a combined manner, that is to say like from a common audio source. The practice of enabling a joint listening experience is a central element here. In particular, provision is made for the acoustic data which are in digital form to be separated into a first data part and a second data part, wherein the second data part contains speech information and the first part does not contain any speech information, with the result that both data parts do not have any content-related overlap. Whereas the first data part which does not contain any speech information is then played back with the aid of first audio playback means which are not directly assigned to any user, the second data part is played back with the aid of additional, second audio playback means which, however, are arranged with respect to a user and are designed such that the user can ultimately perceive the acoustic information corresponding to the two data parts in a combined manner. In this case, “combined” is understood as meaning the fact that the user ultimately perceives all acoustic information as if it came from a common source. In this case, it is essential, as already mentioned, that the audio data of the first data part and the audio data of the second data part do not have any overlap, but rather instead supplement one another in terms of content. The audio information of the second data part is emitted solely via the second audio playback means, whereas the first audio playback means do not play back any audio data of the second data part.

The invention therefore proposes a method for transmitting and playing back acoustic information—preferably in a multimedia application—comprising the following steps of:
a) providing acoustic data which are in digital form and comprise a first data part and a second data part, wherein the first data part does not contain any speech information and the second data part contains speech information;
b) transmitting the first data part to first audio playback means and outputting acoustic signals corresponding to the first data part by means of the first audio playback means;
c) transmitting the second data part to second audio playback means and outputting acoustic signals corresponding to the second data part by means of the second audio playback means;
   wherein the second audio playback means are positioned differently with respect to a user assigned to them than the first audio playback means
which are not directly assigned to any user, in particular in the immediate vicinity of the user, and are designed in such a manner that
the user can hear the acoustic signals emitted by the first audio playback means, and
the acoustic signals emitted by the second audio playback means can be heard substantially only by this user—assigned to the respective second audio playback means.

Speech information which is generally needed by the respective user to understand the listening experience is referred to as speech information in this case, with the result that the second data part primarily contains so-called understanding language. The first data part could possibly likewise contain audio signals of spoken words which are then irrelevant to the understanding or are not speech signals which are comprehensible to the user, however, with the result that no data of an understanding language are transmitted in this way. It would therefore be conceivable, for example, for the first data part to contain a language which is not comprehensible to the user(s), whereas, in contrast, the translation which is comprehensible to a user and then constitutes the understanding language is transmitted with the aid of the second data part. The acoustic signals emitted by the first audio playback means and the acoustic signals emitted by the second audio playback means therefore do not have a common overlap.

In particular, provision may be made for there to be a plurality of users which are each individually assigned second audio playback means, wherein the acoustic signals emitted by the first audio playback means, which are not directly assigned to any of the users, can then be jointly heard by all users, and the acoustic signals emitted by the second audio playback means, which are directly assigned to each of the users, can be heard substantially individually only by the associated user in each case.

Furthermore, the acoustic audio information emitted by the first audio playback means and the acoustic audio information emitted by the second audio playback means does not have any overlaps. The first acoustic signals emitted by the first audio playback means are therefore not emitted, even in a modulated manner, by the second audio playback means. This achieves a joint listening experience for the users, wherein all audio information of the non-understanding language is played back by the general first audio playback means, and the respective audio information of the understanding language is individually transmitted to each user via the second audio playback means. This achieves an improved sound experience, in which case joint listening is enabled with individual data of the understanding language.

The advantages of the method according to the invention clearly come into effect, in particular, in the case of a plurality of users. Whereas, in the solutions known in the prior art, either all users together perceive a centrally played back acoustic signal or each user perceives acoustic signals completely separately from other users, there is a combination of acoustic signals in the solution according to the invention, some of which can be jointly perceived by all users and others of which are individually transmitted to each user. The isolation or complete separation between the various users when perceiving acoustic information is therefore removed and there is again a joint listening experience, wherein certain parts of the acoustic information can nevertheless be individually adapted to the users. Furthermore, the problems which arise in the current prior art described above, such as echoes or double sonication, can be avoided.

In particular, according to one advantageous development of the invention, it is then possible to select the second part of the acoustic data, which is transmitted to the second audio playback means, on the basis of a choice made by the user, in particular in such a manner that the speech information contained in the second data part is available in a language selected by the user. This particularly preferred development of the invention therefore now allows a cinema movie, for example, to be actually played back in such a manner that different users can watch and hear it at the same time, but in the language desired by them in each case. Furthermore, the invention makes it possible to change between the different languages at any time, that is to say even while the movie is running.

Developments of the concept according to the invention relate to measures which additionally optimize, in particular, the playback of the acoustic information relating to the second data part, that is to say the speech information. In this case, it should be taken into account, for example, that the perception of the acoustic information, which corresponds to the first data part and is played back by the central first audio playback means, is naturally influenced by the environment. In this case, the acoustic properties of a space in which the movie is being played back, for example, play a role, in particular, since, depending on the size and shape of the space and the positioning of the first audio playback means in the latter, the corresponding acoustic information is ultimately perceived by the viewers in a special manner. The manner in which the corresponding sound can propagate inside the space and the extent to which this results in Hall effects or attenuation effects, for example, play a role in this case, in particular.

Since the acoustic information corresponding to the two data parts is ultimately ideally intended to be perceived by the user/viewer/listener in the most corresponding manner possible, one advantageous development provides for the second data part to be modified in such a manner that the space or location where the acoustic information is played back is taken into account. This can be carried out, in particular, by using a so-called binaural filter, wherein parameters of the filter are preferably determined on the basis of previously performed test measurements. That is to say, before starting up the system, the manner in which sound propagates within the playback space must be determined, for example, once as part of acoustic measurements, wherein the information obtained in this case is then included in the binaural filter, with the result that, although the speech information or the acoustic information of the second data part is played back in the immediate vicinity of the user, this is done in a manner giving the impression that the playback is effected in a space corresponding to the space in which the user is located. Since this corresponding modification of the second data part should be carried out in the same manner for all users irrespective of the selected language, provision is preferably made for the second data part to be modified centrally and therefore in the same manner for all users even though it would be conceivable in principle to implement the corresponding modification or use of the binaural filter directly in the second audio playback means.

Another development of the concept according to the invention takes into account the fact that not only the playback space or location per se influences the perception of the acoustic information for the user, but also the position of the user with respect to the first audio playback means. Since the acoustic information corresponding to the two data parts is transmitted in different ways, propagation time differences arise, wherein, in particular, the time at which the acoustic information corresponding to the first data part is perceived by a user depends on the position of the user with respect to the first acoustic playback means. This is because the acoustic information is transmitted substantially using sound here, which therefore results in a position-dependent propagation time delay in connection with the distance to the respective first audio playback means, whereas the second data part in contrast is transmitted virtually over the entire distance in electronic form, for example via cable or radio, with the result that, although there will likewise be a delay here as a result of the corresponding processing of the data, it will be the same for all users substantially irrespective of position. In order to be able to take this effect into account, provision is therefore made for the second data part to be additionally modified by the second audio playback means before the corresponding acoustic signals are output in order to be able to take into account the position of the second audio playback means in relation to the first audio playback means. This is substantially the consideration of a time delay in playing back the acoustic information corresponding to the second data part, wherein this modification is then carried out individually for each user in such a manner that the most synchronous possible perception of the acoustic information corresponding to the two data parts is achieved. It is therefore ensured that the acoustic information from both playback means can be ultimately perceived overall by the user in a consistent and homogeneous manner.

In the above-described example of a movie presentation for example, these measures according to the invention ensure that the image and sound can be ideally perceived by the viewer in a manner matched to one another. This applies to the centrally output sound without speech information, but also, in particular, to the sound portion which is individually output according to the invention and comprises the understanding speech information and is acoustically processed in such a manner that it is perceived via the headphones as if it naturally came from the first audio playback means together with the first data part.

Both the first and the second data part may each be transmitted both in a wired manner and wirelessly.

As already mentioned, a preferred example of use for the concept according to the invention is the playback of a cinema movie, which is why one particularly preferred exemplary embodiment provides for optical information, in particular video information, to be played back at the same time as the acoustic information is transmitted and played back. However, in principle, the performance of the method independently of the playback of video information would also be conceivable.

The present invention also proposes a system for transmitting and playing back acoustic information—preferably in a multimedia application—comprising:
a) a storage device for providing acoustic data which are in digital form and comprise a first data part and a second data part, wherein the first data part does not contain any speech information and the second data part contains speech information;
b) means for transmitting the first data part to first audio playback means;
c) first audio playback means for outputting acoustic signals corresponding to the first data part;
d) means for transmitting the second data part to second audio playback means;
e) second audio playback means for outputting acoustic signals corresponding to the second data part;
   wherein the second audio playback means are positioned differently with respect to a user assigned to them than the first audio playback means
which are not directly assigned to any user, in particular in the immediate vicinity of the user, and are designed in such a manner that
the user can hear the acoustic signals emitted by the first audio playback means, and
the acoustic signals emitted by the second audio playback means can be heard substantially only by this user assigned to the respective second audio playback means.

The second audio playback means may be headphones, for example. The second audio playback means may preferably be situated at a distance of up to 1 meter away from the user's ear. They may therefore be, for example, headphones on the ear or playback means installed in a headrest or the like, whereas, in contrast, the first audio playback means are preferably an arrangement consisting of one or more loudspeakers.

In particular, they may be so-called “open headphones” which are designed to make it possible for a user to hear the audio signals from the first audio playback means without disruption. Furthermore, these open headphones each have the second audio playback means which are designed in such a manner that the second audio signal emitted by the second audio playback means is perceived by the user simultaneously with the audio signal from the first audio playback means.

The invention shall be explained in more detail below on the basis of the accompanying drawing, in which:

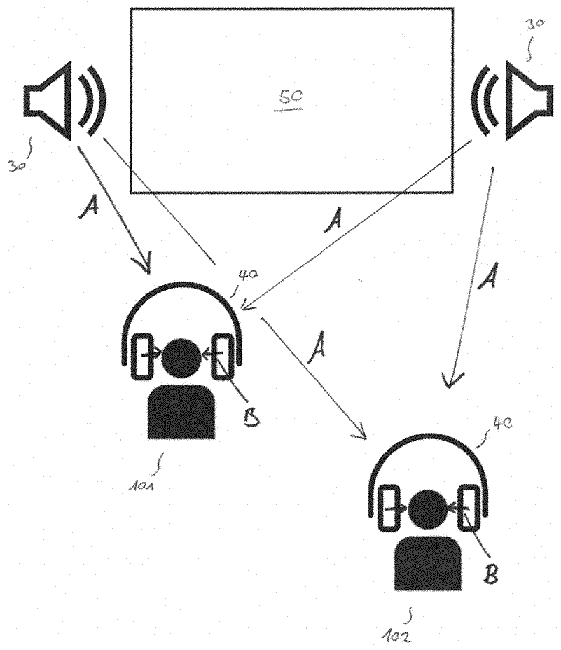

FIG. 1 shows a schematic illustration of the method for transmitting and playing back audio information according to the present invention;

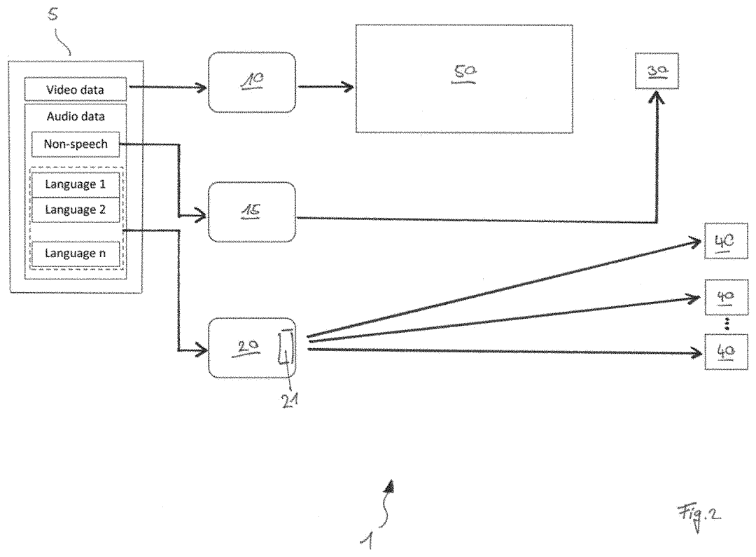

FIG. 2 shows the basic structure of a system according to the invention for carrying out the method for transmitting and playing back audio information;

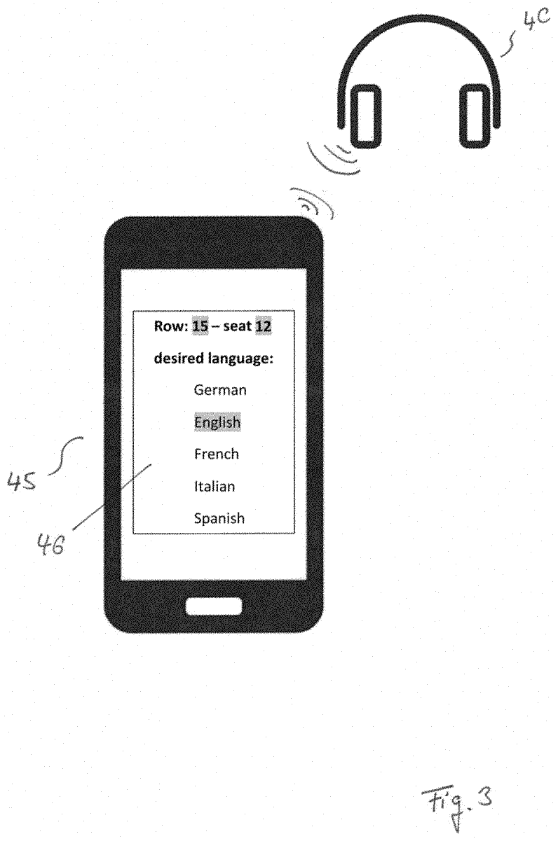

FIG. 3 shows a first example of a user interface for selecting speech information desired by a listener;

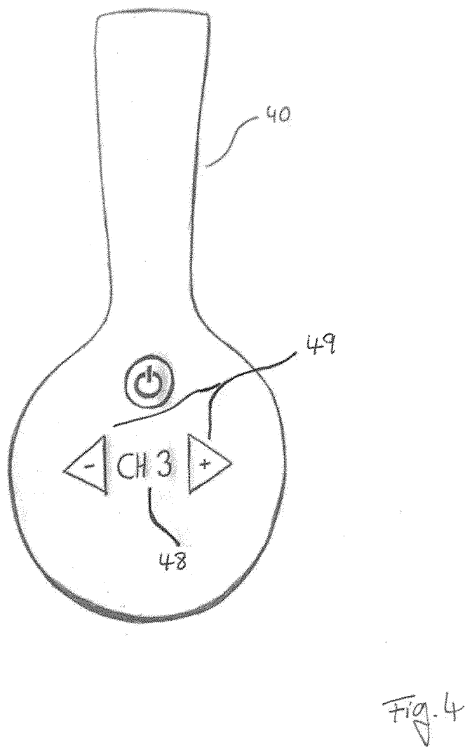

FIG. 4 shows a preferred second exemplary embodiment of a possible way of selecting speech information desired by a user/viewer/listener directly on the second audio playback means assigned to the user/viewer/listener; and

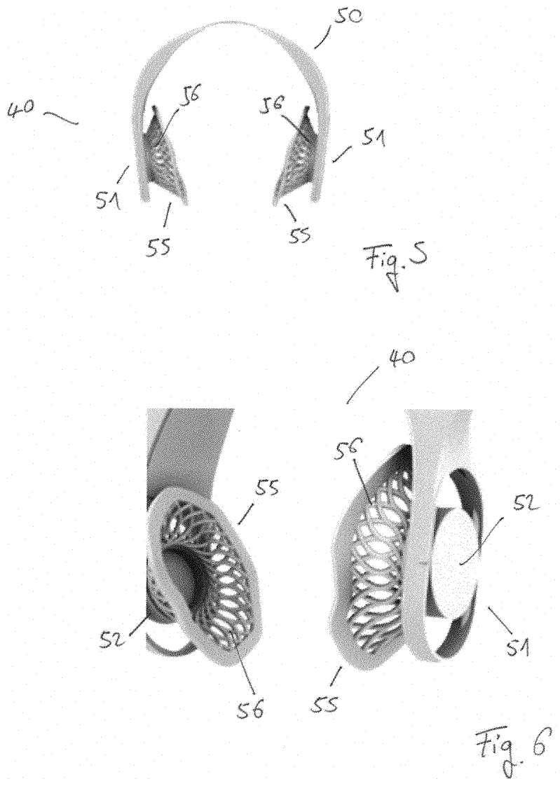

FIGS. 5 and 6 show views of an exemplary embodiment of headphones used in the method according to the invention.

The procedure according to the invention shall be explained below using the example of a movie presentation in a closed space, that is to say a cinema auditorium, for example. As already mentioned, however, the concept is not restricted to closed spaces or rooms, but rather can also be used, for example, when playing back acoustic information outdoors. Use in the private sector, for example in the form of a home cinema in the living room, would also be conceivable since there is often also the need here for a plurality of persons watching a video at the same time to want to hear the speech information in different languages. Finally, it should be pointed out that the transmission and playback of acoustic information according to the invention could also be carried out completely without simultaneously displaying image information.

It should also be pointed out that the terms “user” or “viewer” are used below, but should be understood as being gender-neutral. The present invention relates to users of any gender.

FIG. 1 therefore now schematically shows the method according to the invention for transmitting and playing back acoustic information for the situation in which a plurality of users or viewers 101 and 102 wish to jointly watch a movie played back in a cinema auditorium, but each wish to follow the movie in a different language. It is irrelevant to the system and the method of the present invention how many users participate in playback and how many of them each select which of the arbitrary number of language versions and how long they listen for (if, for example, a language change is selected by a user during the playback of the movie). However, the system is able to detect how many users selected or listened to which language version over which period during a show, which may possibly be advantageous with respect to the settlement with different copyright holders of different dubbed versions.

In this case, provision is initially made for the image information to be displayed on a projection screen or a screen 50, with the result that it can therefore be perceived consistently by all viewers 101 and 102. In order to play back the associated acoustic information, provision is also made of an arrangement of loudspeakers 30 which, depending on the configuration of the sound system, may be positioned at different locations in the cinema auditorium and emit sound into the space in such a manner that it can be perceived by all viewers in said space. In the exemplary embodiment illustrated, it is assumed that the loudspeakers 30 are in the region of the projection screen 50 or the screen, wherein—as already mentioned—there may also be considerably more loudspeakers and they may be positioned in a manner distributed over the space. However, it is important that these loudspeakers 30 are designed to play back acoustic information in such a manner that said information can be perceived by all viewers at the same time.

In previous systems, provision was made for all audio information to be played back via the loudspeaker system 30 which can be perceived by all viewers. However, this means that the viewers 101 and 102 can follow the movie only in a single language.

Therefore, the invention provides for the acoustic information associated with the video image to be played back in a modified manner, thus enabling individual adapted playback, in particular playback adapted with respect to the language, for the viewers 101 and 102.

In this case, the invention is based on the idea of splitting or subdividing the acoustic information into two portions which do not have any overlap in terms of content and then transmitting these different portions in different ways in a special manner to the listeners, with the result that the two portions are then homogenously perceived as a natural sound pattern. For the exemplary case of a cinema presentation, this means that all of the acoustic information originally available is divided or separated, on the one hand into a first portion which does not contain any synchronizable or synchronized speech information (in the case of a movie audio file subdivided into DIALOG, MUSIC & EFFECTS parts for example, this would then be the MUSIC and EFFECTS parts), and on the other hand into a second portion (the DIALOG part in the above example) which contains—ideally exclusively—synchronizable or synchronized speech information. It is usually comparatively simple to accordingly divide the acoustic data and such a division is generally already innately present anyway since the sound information of a movie is generally provided in digitized form in a plurality of files, wherein the speech information—before the so-called mastering—is stored in particular, uniquely identifiable files. In order to carry out the present invention, the initial division of all of the acoustic information is therefore ideally not required at all, but rather it is possible to resort to the acoustic information which has already been provided in a subdivided manner. The second data part which corresponds to the second section of the divided acoustic information and is intended to contain the speech information then therefore in principle consists of the corresponding files.

In contrast, the first data portion which corresponds to the first section of the divided acoustic information and does not contain any synchronizable or synchronized speech information can be made available to all viewers 101 and 102 in the same manner irrespective of the language preference, which is why the procedure according to the invention provides for the acoustic signals corresponding to this first data part to be emitted in a centralized manner via the loudspeaker system 30 in such a manner that—like in a conventional cinema presentation—all viewers 101, 102 can in principle hear the corresponding acoustic information together and at the same time. Ultimately, the projection screen 50 and the loudspeaker system 30 therefore play back the movie in a form which can be perceived in the same manner by all viewers 101, 102 but initially does not yet contain any dialogs or any speech information. The transmission of this portion of the acoustic information is schematically illustrated in FIG. 1 by means of the arrows A, wherein the viewers 101, 102 will naturally hear the acoustic signal from all loudspeakers 30 of the system.

In contrast, as already mentioned, the synchronizable or synchronized speech information of the movie forms the second data part of the acoustic information which, according to the invention, is made available to the viewers 101, 102 in an alternative way. For this purpose, provision is made for further audio playback means 40 to be individually assigned to each viewer 101, 102. These audio playback means are illustrated in the form of headphones 40 in the present case, wherein it is initially important that these further audio playback means 40, in contrast to the loudspeaker system 30, are arranged in the immediate vicinity of the respectively assigned viewer 101 or 102. These second audio playback means 40 therefore need not necessarily be headphones, but rather it would also be possible to provide, for example, loudspeakers which are individually assigned to a viewer 101 or 102 and for this purpose are situated in the immediate vicinity (for example at a maximum distance of 1 m) of the viewer 101 or 102. In particular, provision is made for the acoustic signals emitted by headphones 40 or by the second audio playback means to be able to be perceived solely by the viewer 101 or 102 assigned to them, that is to say only this viewer 101 or 102 can hear the corresponding acoustic signals.

The speech information to be played back by the individually assigned headphones 40 is now transmitted to the headphones 40 in such a manner that the speech information is made available to the respective viewer 101 or 102 in the language desired by the viewer. This is schematically illustrated in FIG. 1 by means of the arrows B. That is to say, the viewer 101 illustrated in FIG. 1 therefore hears the speech information associated with the movie in a first language, for example in German, with the aid of the headphones 40, whereas, in contrast, the speech information played back through the headphones 40 is made available to the second user 102 in a second language, for example in English. Both viewers 101 and 102 can therefore now receive the speech information according to their individual choice.

In this case, it should be pointed out that the users will usually select the version of the speech information desired by them at the beginning of or before the presentation, but it can be possible at any time to change to another version even while the presentation is running. Each second audio playback means provides the user assigned thereto with all available speech information, from which this user can then select or change the desired language version at any time—for example directly on the second audio playback means itself (FIG. 4) or using an additional device (FIG. 3) which is installed on the seat or is loose.

The important factor is that the headphones 40 of the system according to the invention are designed in such a manner that the respectively associated viewer 101, 102 does not hear solely the acoustic information played back by the headphones 40 but also, at the same time, the acoustic information emitted centrally via the loudspeaker system 30. Both viewers 101, 102 therefore receive acoustic signals in two different ways A, B, on the one hand the signals which are output via the loudspeaker system 30 and do not contain any speech information and, on the other hand the speech information individually passed on via the headphones 40 in the language desired by the respective viewer/listener/user. The hearing of the viewers 101, 102 then in turn combines or supplements the received or heard information in each case, with the result that, in combination, acoustically homogeneous overall information—additionally also corresponding to the video image in the case of the cinema presentation—is heard, but is respectively adapted to the corresponding—linguistic—desire of the viewer.

That speech information which is generally comprehensible to the user—so-called understanding language—is referred to as speech information, wherein audio information containing understanding language is primarily—preferably exclusively—transmitted via the loudspeakers individually assigned to the users or via the headphones 40, whereas the audio signals output via the loudspeaker system 30 do not contain any audio information containing understanding language. The audio signals output via the loudspeaker system 30 and the audio signals output via the individually assigned loudspeakers or the headphones 40 therefore do not have any overlaps.

Documentaries or reports are an example of use of speech information which is not an understanding language and is therefore transmitted using the first data part. Here, the language respectively selected by the user or viewer 101, 102 is transmitted as an understanding language via the individually assigned loudspeakers or via the headphones 40, whereas an original soundtrack containing the original language and background noise is emitted as a non-understanding language via the general loudspeaker system 30.

For clarification, it is emphasized here that the acoustic information emitted via the headphones 40 may also contain, possibly to a certain extent, additional audio information such as background noise or the like owing to production or recording. However, this second data part of the audio signals preferably consists solely of speech information, more precisely the understanding language explained above.

An advantage of the solution according to the invention is that at least one part of the acoustic information, that is to say in particular the part which does not contain any speech information, is centrally played back by the loudspeakers 30 and is therefore jointly heard by all viewers. On the one hand, this results in a joint perceptual experience, which is considerably more pleasant than a variant in which the different participants receive all acoustic information solely via headphones assigned to them. On the other hand, this joint listening is also distinguished by the fact that it is conveyed to the user that the user experiences the audio experience as part of the space, for example the cinema auditorium. In this case, in the present invention, the aim is for the user to have a listening experience individualized by means of the respective understanding language without noticing it, since the mutually complementary interaction of the understanding language audio information and non-understanding language audio information provides the user with a common sense of hearing. Ultimately, the viewer is given the impression that he perceives the movie in the same manner together with all other viewers, wherein the playback of the acoustic information is nevertheless individually adapted, in particular with respect to the language.

The listening experience is improved again here in comparison with the solution in EP 1 427 253 A2 by virtue of the fact that there is a naturally spatial perception for the user. A user in a rear corner will therefore perceive the audio information differently overall than a user sitting directly in front of the projection screen, for example. The retention of this spatially natural, acoustically plausible perception is achieved in this case by virtue of the fact that the audio information of the second data part is a content-related addition which is matched to the audio information of the first data part, but does not change this audio information of the first data part—jointly perceived by all users.

This is the crucial difference from the system in EP 1 427 253 A2 described at the outset. This is because, in the prior art, this spatial perception effect is intended to be eliminated (since here all users are intended to have an identical listening experience irrespective of their position), which is achieved by virtue of the audio signals output via the individual loudspeakers changing or being destructively superimposed on the jointly output audio signals in such a manner that a position-independent listening experience is achieved. According to the above example, the MUSIC and EFFECTS parts are therefore again output via the central loudspeakers for all viewers in the solution in the prior art, but the local loudspeakers are used to also output the MUSIC and EFFECTS parts again in addition to the DIALOG part in order to achieve the desired position-independent listening experience for the entire listening area or for all participants.

However, in extreme cases, this can result in the listening experience achieved in the prior art differing from a visual perception, which is perceived to be unpleasant and is the case, for example, if the playback of the acoustic information is designed for a position which is centrally in front of the projection screen, but the viewer is actually on one side of the projection screen. Whereas the jointly output audio information is therefore additionally also output and accordingly modified by the individual loudspeakers in the prior art, there is deliberately content-related separation between the centrally output audio information and the locally output audio information in the procedure of the present invention in order to be able to retain the spatially natural perception effect.

In other words, whereas in the solution according to the present invention the audio information played back from the second audio playback means supplements the audio information played back from the first audio playback means, wherein this supplementation takes place in terms of content and—as explained below—in a spatially-acoustically filtered manner with respect to the second audio information, provision is made in EP 1 427 253 A2 for the audio information played back from the second audio playback means to be superimposed on the audio information played back from the first audio playback means, wherein this superimposition takes place in terms of content and with frequency modulation with respect to the second audio information. In addition to an improved listening experience, a further advantage of the present invention is also the fact that the volume of data corresponding to the audio information via the second audio playback means is smaller than is the case in the prior art. The volume of data to be transmitted to the listener in the second way can therefore be reduced, with the result that the method can ultimately also be carried out with lower technical complexity.

In this case, the possibilities described below involve additionally optimizing the acoustic information corresponding to the second data part, in particular, wherein these measures contribute to the combination and mutual supplementation of the acoustic signals transmitted in the different ways by a viewer's hearing being improved.

In this case, it should be initially taken into account that the acoustic signals emitted by the central loudspeaker system 30, that is to say the sound waves, are generally naturally influenced or modified by the space characteristic/nature before they arrive at the viewers 101 and 102 and are heard by the latter. Influencing takes place in this case, in particular, by the playback space or location since the sound output by the loudspeakers is reflected at walls or other surfaces inside the space and is additionally modified—for example partially attenuated in certain frequency ranges—in a manner characterizing the space before it arrives at the viewers 101, 102 and is heard and perceived by the latter. A classic example of this is that the shape and size of a space influence, for example, the reverberation in a particular manner. Insulating surface, wall or ceiling regions may also attenuate or particularly influence certain frequencies of the acoustic signal, wherein this is also different in each case depending on the playback location or space.

The distance between the viewer or listener and the central loudspeaker system and the direction from which the sound signals arrive at the viewer or listener are also important since the human hearing, in cooperation with the brain, is able to assign its perceived listening events to particular directions. This is because, as soon as a sound source is no longer arranged centrally in front of a listener, identical so-called vibration phases reach the left-hand and the right-hand ear of the listener after different propagation times and at different levels (so-called interaural propagation time differences, ITD, and interaural level differences, ILD) and cause the hearing to perform space localization in the virtual sound field. These are minute differences since propagation time differences can already be evaluated by the human hearing for directional localization from a magnitude of 10 μs. The auricles have an important role here. They act as mechanically acoustic filters and ensure that the sound has a respectively typical frequency response profile at the eardrum depending on the direction of arrival, which is referred to as a head-related transfer function (HRTF).

A procedure which is known from the prior art for characterizing, in particular, the sound perception effect initially described is to carry out so-called binaural measurements. In this case, acoustic measurements are used to investigate how a sound signal is influenced by a corresponding room or location, wherein the measurements can be taken as a basis for determining certain parameters which qualitatively describe the manner in which the space or location modifies the sound signal.

It is also known practice in the playback of acoustic signals—in particular via headphones—to modify these signals with the aid of so-called binaural filters on the basis of the previously explained information obtained by acoustic space measurement before the signals are emitted by headphones. In the exemplary case of a cinema presentation, these binaural filters are used to influence or modify the acoustic signal before it is emitted by headphones in such a manner that it gives the impression that it has been emitted overall in one space and from one direction corresponding to the parameters of the associated binaural filter.

This procedure is now preferably also carried out when transmitting and playing back the speech information output via the headphones 40. That is to say, the second data part transmitted to the headphones 40 is modified, in particular spatially-acoustically filtered, according to one advantageous development of the invention, in such a manner that, although the corresponding acoustic information is transmitted directly to the respective viewer 101, 102 to the headphones 40 and is played back by the latter, this information is played back in a modified manner on account of the filtering such that there is the impression that the playback will not be carried out locally via the headphones 40, but rather instead centrally overall into the space via the loudspeakers 30. The corresponding viewer therefore perceives the speech information emitted via the transparent headphones 40 in the same manner as the acoustic information which is centrally emitted via the space-filling loudspeakers 30 and does not contain any speech information. The quality of the listening experience is considerably enhanced thereby since both parts of the acoustic information can be perceived by the viewer in the same manner and therefore can be readily perceived, in a manner combined by their hearing, as an overall perception. For the individual viewer, there is therefore again increasingly the impression that the viewer will hear all acoustic information together with all other viewers.

Ideally, the parameter values used for the binaural filter are determined experimentally on the basis of measurements. This means that, for each space in which playback is intended to be carried out in accordance with the method according to the invention for example, a corresponding measurement which characterizes the sound behavior of the space is carried out once. However, the information obtained in this case can then be permanently used to implement the method according to the invention provided that the acoustic properties of the space do not seriously change.

An exemplary procedure for implementing the binaural filters is as follows.

As a first step, a binaural spatially acoustic measurement of the loudspeakers 30 in the playback space is first of all carried out and is extracted into so-called “binaural room impulse responses”. For this purpose, a so-called artificial head, in which a microphone with an omnidirectional characteristic is fitted in place of the ears at the entrance of the ear canals with the emulation of the auricles, is used to measure the spatially acoustic properties of each loudspeaker 30 of the system in the ideal sitting position, that is to say at the same distance from all loudspeakers 30 in the center of the space, with respect to the artificial head. In this case, measurement is carried out using a logarithmic sweep over the frequency range of 20 Hz to 20,000 Hz, which covers the human audible range.

The aim is to virtualize the playback behavior of the loudspeakers 30 in the respective space in the headphones 40 of a user during subsequent use of the system by convoluting the audio signal with the “binaural room impulse responses”. In this application, soundtracks or the acoustic information is/are separated into two parts, a first part for playback on the real loudspeakers 30 in the space (that is to say the acoustic information relating to the music and effects in the exemplary cinema scenario) and a second part of acoustic information provided, by means of convolution with “binaural room impulse responses”, for playback via the loudspeakers virtualized in the headphones 40 (that is to say the understanding language in the exemplary cinema scenario).

In the case of a movie in the 5.1 surround format—that is to say with loudspeakers on the left, on the right, in the center, at the back left, at the back right and subwoofers—the measurements then result in a pair of impulse responses, that is to say for the left-hand and right-hand ear, for each loudspeaker.

These pairs of impulse responses are loaded into a convolver (convolution algorithm) in the playback system. The loudspeaker signal respectively determined for virtual playback in the headphones 40 is then convoluted there with the two impulse responses for the right-hand and left-hand ear for each loudspeaker. The playback system thus convolutes the 5.1 playback signals with the measured binaural impulse responses of the real listening space.

Overall, the speech signal is thereby conditioned in such a manner that it is heard and felt in the headphones 40 as if the speech signal came from the real loudspeakers 30 in the playback space. An “out-of-head perception” of the speech signal is therefore effected. As already mentioned, the exemplary headphones 30 are in the form of open headphones, which means that all noises outside the headphones 30, as well as the signals directly coming from the headphones, can be jointly perceived by the user and can therefore be combined in the brain to form an overall listening experience.

As a result of the described procedure, a spatial filter is therefore added to the audio information played back by the second audio playback means, which spatial filter artificially emulates the naturally spatial manner of the acoustic perception by the human ear of the audio information played back by the first audio playback means for the playback of the audio information from the second audio playback means and their acoustic transmission from loudspeakers via the presentation space and via the head and auricles of the listener into their ear canal. This results in an integrated sound pattern and a naturally spatial listening experience or a naturally location-based spatial perception for the listener.

The signals which are used in the manner described above and have been binaurally conditioned initially function 100% correctly only at the location at which measurements were carried out with the aid of the artificial head and also primarily when the head posture of the user corresponds to that of the artificial head. In contrast, if the user turns their head, the spatial replica in the headphones would also turn, whereas it remains fixed at the loudspeaker positions in the real listening space. Therefore, further-reaching measures which can be used to again additionally optimize the playback of the acoustic information via the headphones 40 are described at a later time in order to be able to achieve a further improved match to the playback via the loudspeakers 30. On the basis of a single binaural measurement or only a few binaural measurements, the playback of the acoustic information via the headphones 40 can then be adapted to the actual position of the user and to their head posture.

Instead of an individual binaural measurement of the space provided for playback, it would moreover also be conceivable to determine, on the basis of various measurements, parameter values which can be assigned to different categories of spaces. This would make it possible to use parameter values for the binaural filter which do not have to be previously individually determined for a particular space, as a result of which the complexity overall is reduced slightly.

It should be pointed out that the modification of the second data part which has just been described will initially be carried out in the same manner for all listeners since they are also all in the same space. Accordingly, provision is ideally made for the binaural filter to be used centrally, with the result that the data transmitted to the headphones 40 are already transmitted in an accordingly modified manner.

As an alternative to the above explanations, however, it would also be conceivable to configure the second audio playback means, that is to say the headphones for example, in such a manner that they are able to automatically carry out such a measurement—independently or after activation—in an automated manner and to in turn automatically convert the result into a corresponding filter for precisely these second audio playback means themselves—or, in the master-slave mode, likewise for any desired number of coupled further second audio playback means. This procedure is appropriate, in particular, when the filter must be accordingly adapted in a flexible or individual manner, which is the case, for example, during use in the home cinema sector or for private purposes in the living room or the like.

However, a further modification of the data or playback of the acoustic information can then be carried out in the headphones 40 themselves in order to additionally take into account—as already discussed above—the position and possibly the head posture of the user. In this case, it is taken into account that the viewers 101, 102 or listeners are situated in different regions inside the space and are accordingly at different distances from the different loudspeakers of the central loudspeaker system 30.

It is known that sound, and therefore the acoustic information A played back by the loudspeakers 30, propagates at a speed of sound of 343 m/s, with the result that, in the exemplary embodiment illustrated in which the two loudspeakers 30 are arranged beside the projection screen 50 and therefore in the front region of the space, the user 102 will receive, that is to say hear, the acoustic information emitted by the two loudspeakers 30 at a slightly later time than the viewer 101 who is closer to the loudspeaker system 30. Even more generally, it can be assumed that the loudspeakers 30 will be arranged in a distributed manner in a space, wherein individual propagation times for transmitting the acoustic information then result for each viewer with respect to each individual loudspeaker.

However, the second data part is transmitted to the headphones 40 electronically, for example via cable, radio, WLAN, Bluetooth, etc., in such a manner that it can be assumed that substantially simultaneous transmission at the speed of light to all viewers is effected here. If it is also assumed that the processing of the signal, which is required in the headphones 40, and the playback of the associated information are also carried out with an identical delay, this means that this part of the acoustic information corresponding to the second data part would in principle be heard at the same time by all viewers 101, 102. In the illustrated example, this would result in a noticeable time delay in the arrival of the centrally output non-speech information in comparison with the speech information, in particular in the rear rows of seats of the cinema auditorium.

Even if the propagation time differences for the non-speech information A are comparatively short, they may nevertheless result in a perceptible effect such that the acoustic signals which do not contain any speech information, on the one hand, and the acoustic signals containing the speech information, on the other hand, are not actually heard exactly at the same time.

Since this may again have an adverse effect on the listening experience, provision is preferably made to adapt the time at which the second acoustic information is played back in a manner corresponding to the position of the viewer. This means that the headphones 40 initially receive the second data part substantially at the same time, but take into account a certain time delay when playing back the corresponding acoustic information in order to ensure that this information is heard in sync with the hearing of the acoustic non-speech information emitted via the central loudspeakers 30. This again considerably enhances the listening experience for the viewers 101 and 102.

In addition to the distance from the loudspeakers 30, the absolute angle of incidence of the sound source and/or the direction from which the acoustic non-speech information emitted via the central loudspeakers 30 arrives at the viewer can furthermore also be taken into account.

The angle of incidence can be simulated psychoacoustically in the headphones using the so-called ITD (interaural time difference). This is because, if a sound source emits a signal directly from the front, there are no time differences between the arrival of the sound at the left-hand and right-hand ear. The listener therefore has the feeling in the headphones that a sound source is positioned centrally in front of them if the corresponding sound signals are played back at the same time at both ears. In contrast, if the sound source were positioned on the right, for example, the sound would arrive at the right-hand ear first and would only arrive at the left-hand ear—with an ear distance of 16 cm—with a delay of approximately 0.65 milliseconds. This ITD can therefore provide the listener with the feeling that the sound would arrive from the right, even though both levels may be identical.

Since it can be assumed in a cinema auditorium that each viewer looks directly forward, there is always an angle in absolute terms with respect to the center of the projection screen, which angle is variable depending on the sitting position of the viewer/listener. This “static” situation can also be psychoacoustically simulated by introducing a (further) time delay of the signal playback between the right-hand and left-hand ear. For this purpose, a time delay of between 0 ms and 0.65 ms, depending on an angle in the range of 0-90 degrees, is introduced between the playback of the signal at both ears. If the sitting position of the viewer and also the position of the central loudspeaker are therefore known, the absolute angle of the viewer with respect to the central loudspeaker and therefore the level of the required time delay can be calculated using trigonometric relationships.

For each viewer, their position and head posture should therefore be ideally known in order to be able to optimize the playback of the speech information in the manner explained above. This information can be determined, for example, as described below.

The distance and the viewing angle and therefore the “hearing” angle for each seat are first of all stored in a so-called lookup table. It is then necessary to determine which seat is actually occupied by the viewer, in which case this can be achieved, for example, using the methods mentioned below:

I) Indoor GPS: by means of 4 synchronized transmission modules and one reception module, which is integrated in the headphones for example, the position in the space can be calculated by way of non-linear optimization using the 4 propagation time differences of corresponding signals (for example of ultrasonic signals used for this purpose) and by solving a fourth-order non-linear equation and can be used as a basis for the signal playback delay.

II) RFID tag: each seat is equipped with an RFID tag and each set of headphones is equipped with an RFID reader. As soon as the viewer is in their seat, the headphones identify the seat in which the viewer is situated. The sitting position for each RFID tag is again stored in a lookup table, with the result that the position of the viewer can be easily determined.

III) In a simple form, the second audio data may furthermore also be transmitted in a wired manner, wherein the headphones are then each connected to a corresponding connection, for example on the associated seat, in the cinema auditorium. Since the position of the headphone connection is known in this case, the position of the headphones can be immediately determined thereby, with the result that the latter can either independently calculate a suitable time delay or are accordingly informed of the latter.

IV) Furthermore, provision could also be made for the headphones or an operating unit assigned to the headphones to have means for inputting the position or the seat and for a corresponding propagation time delay to then be calculated and/or communicated on the basis of this position.

V) Finally, a beacon technology based on BLE (Bluetooth Low Energy) would also be an option for determining the position of the viewer. In this case, a BLE-enabled device always transmits the same UUID standard advertisement message uniquely identifying the transmitting device (=beacon) at a regular interval. A seat of the receiver device can then be located by evaluating the corresponding UUIDs and the associated signal strengths. With a signal range of up to 50 m, this technology provides a good relationship between distance and accuracy and is therefore a useful alternative to RFID, NFC or WLAN technology.

As soon as the position of a viewer is known, the distance and the absolute angle with respect to the central loudspeaker can then be calculated and two individual “static” delays can accordingly be set for the right-hand and left-hand ear. The result is therefore initially a general propagation time delay on account of the distance, but this is then also individually modified for both ears depending on the angle.

In this case, it should be pointed out that the correction just explained relates to a single loudspeaker of the loudspeaker system provided for playing back the first audio data. If the system consists of a plurality of loudspeakers and if the latter are arranged in a distributed manner, the distance of the viewer and the angle of incidence of the associated sound can be ideally individually taken into account for each individual loudspeaker. This would result in the corresponding second audio data then each receiving propagation time modifications which correspond to the individual loudspeaker and are additionally also modified for both ears depending on the angle.

Since, however, such a procedure would require multichannel transmission with more than two channels and is therefore associated with considerable outlay, it is possible to also resort, if appropriate, to a technically less complicated solution. In this case, the so-called binaural impulse responses are recorded for each loudspeaker and the signal from all loudspeakers of the central loudspeaker system is convoluted with these signals, which then results overall in a binaural mean value or mix which is transmitted. In this case, the two signals for the right-hand and left-hand ear are again delayed, but only in relation to a centrally placed “main” or center loudspeaker of the system, which results in the speech information actually being mixed in an exactly synchronized manner only with respect to this center loudspeaker. With respect to the further loudspeakers, with this manner of execution which is described by way of example, the result would be slight deviations or errors which can be disregarded, however, for the overall effect desired according to the invention.

Moreover, it would also be conceivable to take into account the fact that the relative viewing angle of the viewer can also change with their head movements. This angle can be determined, for example, with the aid of a gyro sensor which is installed in the headphones. However, this sensor first of all requires calibration which could be carried out as follows: at the moment at which the viewer takes their seat, leans back and the RFID tag is read, it can be assumed that the viewer is looking forward and the relative viewing angle is therefore equal to zero, but the absolute angle corresponds to the calculation of the sitting position with respect to the center of the projection screen, that is to say to the value stored in the lookup table. If the gyro sensor is calibrated in this manner, it subsequently identifies any deviation from the angle stored in the lookup table. In addition to the delay for the distance and the absolute viewing angle, the headphone system then delays the signal for signal playback at the right-hand or left-hand ear relatively and dynamically in real time depending on the head rotation. Therefore, the ITD can be adapted for any head movement, with the result that the linguistic information—even though not played back by the first audio playback means/loudspeakers fixed in the space, but rather by the “movable” second audio playback means/headphones (or the like)—remains “spatially fixed” for the user at any time.

Ultimately, the procedure according to the invention and the additional optimizations with respect to adapting the signal playback to the headphones therefore result in an extremely high-quality listening experience for the viewers, in which case the latter can nevertheless hear acoustic signals in a modified manner desired by them—in particular in terms of the language.

FIG. 2 schematically shows the configuration of a corresponding system 1 which can be used to carry out the method explained above.

In this case, a central storage unit 5, for example in the form of a server, which provides the video and audio data of the movie, is first of all required. In this case, as schematically illustrated, the audio data are divided into a first portion which does not contain any synchronizable or synchronized speech information and a second portion which contains synchronizable or synchronized speech information, in which case the second part may be present multiple times, in particular in n different variants, where n corresponds to the number of available differently synchronized language versions of the movie.

In this case, the video data are then initially made available to a unit 10 which causes the playback, for example on the projection screen, the screen or by virtual reality 50 of the system 1. The unit 10 may be a corresponding projector or a driver for a corresponding display, as is known from conventional movie and video presentation systems.

The first part of the audio data, that is to say that part which does not contain any speech information, is again intended to be jointly played back centrally for all viewers and is accordingly transmitted to a loudspeaker system 30 via a unit 15. These are also the already known components used for movie playback, with the result that there is no need for any changes to the system in comparison with a conventional movie or video presentation. The important factor here is only the fact that only the first data portion, that is to say the non-speech portion, is passed to the unit 15 and is forwarded by the latter, but not—as previously—the complete audio data.

This is because the second portion containing the language is made available to a distribution unit 20 which is ultimately responsible for transmitting the corresponding second data to the loudspeakers or headphones 40 individually assigned to the viewers. The second portion containing the language—that is to say the understanding language portion—does not have any overlap of audio data with the first part of the audio data in this case, wherein the first part of the audio data contains only audio data with non-understanding language. In this case, the data may be transmitted from the distribution unit 20 to the headphones 40 both in a wired manner and wirelessly. The important factor is that each loudspeaker or set of headphones 40 must be able to receive at least the version of the second data which corresponds to the desired language. This can be carried out, for example, by setting up individual communication between the unit 20 and the corresponding headphones 40 and therefore only transmitting the data in the version corresponding to the desired language to the respective headphones 40. Alternatively, all different language versions could also be simultaneously transmitted by the unit 20 and therefore to all headphones 40, wherein, although the headphones 40 then receive all data, they use and ultimately play back only the portions of the data corresponding to the desired language version.

The binaural filter corresponding to the propagation of sound in the space is preferably applied in the same manner to all second data parts, as already mentioned. Accordingly, provision is preferably made for this filter 21 to be implemented in the distribution unit 20, with the result that the data output by this unit 20 have already been modified in a suitable manner. In this case, the audio data stored in the central storage unit 5 are initially in a form independent of the playback space.

However, it would also be conceivable for the data to already be modified by the storage unit 5 with the aid of a binaural filter before they are forwarded to the unit 20, or for the data to already be stored in the storage unit 5 in a version modified by the binaural filter. Finally, it would also be conceivable for a separate filter to be situated in each set of headphones 40 or in each second audio playback means, which filter modifies the playback of precisely these headphones 40 or second audio playback means.

The headphones 40 themselves should at least carry out the above-mentioned second modification when playing back the speech information by applying a corresponding time-delay filter. For this purpose, it is necessary for the headphones 40 to identify their position within the space or know which time delay should be applied, wherein the different procedures I) to IV) mentioned above would be conceivable for determining the position, in particular.

In order to ensure that all viewers synchronously perceive the acoustic information irrespective of the language selected by them, provision is made for the audio versions corresponding to the different languages to be synchronously started and to be oriented in this case to the master, for example to the first audio data without language (“non-language” or “non-understanding language”). Feedback which communicates the time stamps (current position) of the respective language version files (language 1, language 2, language n . . . ) can be used during playback to identify whether the playbacks diverge or become asynchronous. In this case, there is a threshold value above which a listener would notice the divergence. Before this is reached, the system will intervene and will accordingly correct the playback position of the speech information without the listener noticing an impairment. In contrast, if the drift of the tracks assumes an excessively high threshold value, a harder mechanism (jump) corrects the affected track.

Although this would be perceptible in the short term to the listener, it is necessary in extreme situations as a correction as part of a back-up mechanism.

With respect to the headphones 40, it should be noted that they must be configured—as mentioned above—in such a manner that, in addition to playing back the signals corresponding to the second audio data, they must also simultaneously make it possible to hear the sound signals corresponding to the first audio data. This means that the headphones 40 must not block or suppress external sound signals, but rather must allow such signals to pass through. In this sense, it is also possible to refer to “transparent headphones”. This can be achieved, for example, by virtue of the corresponding loudspeakers of the headphones 40 not terminating in a sound-reducing manner around the ears of a user, but rather being designed in such a manner that external sound waves can likewise enter the ear canal of the listener without hindrance and change. For example, an arrangement of the loudspeakers at a distance of up to 1 m which be conceivable, in which case the loudspeakers may then be integrated or installed in a comparable manner in a headrest, for example. The second playback means therefore need not necessarily be headphones.

Finally, two exemplary variants for selecting and transmitting the second data part to headphones 40 belonging to a viewer shall be explained. In this respect, FIG. 3 shows a corresponding system which consists of the headphones 40 themselves and a communication device 45 which is connected to the latter and is assigned to the user. For example, this communication device 45 may be a cellphone belonging to the user which communicates in a wireless or wired manner with the distribution unit 20 shown in FIG. 2 and, on the other hand, is connected to the headphones 40 in a wireless manner—for example via Bluetooth—or in a wired manner.

In the case illustrated, application software is installed, for example, on the cellphone 45 and makes it possible for the user to participate in the transmission method according to the invention, wherein wireless or wired communication with the distribution unit 20—for example as part of a WLAN network or by means of Bluetooth—is first of all set up with the aid of the application software and the user can then input the language desired by them, on the one hand, and for example their seat in the cinema auditorium, on the other hand, using a graphical user interface 46, for example. It goes without saying that it is not necessary to manually input the seat if—as explained in the above examples—the system itself is able to identify the position of the user. During movie playback, the second data are then transmitted in a wireless or wired manner and are then forwarded to the headphones 40. In this case, the data are preferably transmitted directly from the distribution unit 20 to the headphones 40, with the result that the cellphone 45 is primarily used in this case as a remote control. Alternatively, it would also be conceivable to transmit the data with the interposition of the cellphone 45. In this—less preferred—case, the cellphone 45 forwards the data received from the distribution unit 20 to the headphones 40. At the same time, the position information can also be used to accordingly adapt the duration of the time delay for playing back the second audio data.

With respect to the initially described variant, it would preferably also be conceivable for the headphones 40 themselves to have corresponding means for setting up a communication connection to the distribution unit and for selecting a language desired by the viewer. This embodiment is illustrated in FIG. 4 which shows an exemplary side view of corresponding headphones 40. A display 48 which displays the selected language channel is situated on the side of the headphones in this case, wherein this language channel can be changed with the aid of simple operating buttons 49 or a digital or sensory operating panel. In this case, the headphones 40 are coupled to the central distribution unit 20 via corresponding communication means (for example radio, Bluetooth, WLAN or wired).

FIGS. 5 and 6 finally show a conceivable exemplary embodiment of headphones 40 which are configured in such a manner that, in the sense of the present invention, they make it possible to perceive the acoustic signals emitted by the headphones 40 and also simultaneously the centrally output acoustic signals.

In accordance with conventional headphones, the exemplary embodiment illustrated in FIGS. 5 and 6 also has an approximately U-shaped frame 50, on the two mutually opposite ends of which corresponding loudspeakers 51 for emitting the acoustic signals are arranged. It is possible to additionally perceive external acoustic signals, that is to say in particular the acoustic signals emitted by the central loudspeakers 30, by virtue of the fact that, starting from the respective approximately cylindrical loudspeaker housing 52, there is a conically expanding supporting element 55 which is arranged on the head of a listener in a manner surrounding the respective ear, but the wall 56 of this supporting element 55 is sound-permeable. In the exemplary embodiment illustrated, the sound permeability is achieved by virtue of the wall region 56 having a lattice-like design and accordingly having a multiplicity of openings which make it possible for sound to pass through substantially without hindrance. Alternatively, it goes without saying that it would also be conceivable to design the wall region 56 of the supporting element 55 in a closed manner, but it is then necessary to use a material which is sound-permeable. Foam rubber or a comparable material, for example, would be conceivable in this case.

In the illustrated form, the headphones 40 therefore make it possible to perceive the two portions of acoustic signals, wherein it is ensured, on account of the arrangement of the actual loudspeakers 51 in the immediate vicinity of the user, that substantially only the user of the headphones 40 hears the acoustic signals played back by the headphones 40. Although these signals may also possibly be perceived very weakly by an adjacent listener, the listening experience according to the present invention is not decisively influenced thereby.

As already mentioned, however, it would also be conceivable in principle to use differently configured second audio playback means as an alternative to the headphones illustrated. If said audio playback means are arranged in a suitable manner, in particular in the vicinity of the listener, the naturally spatial sound experience strived for according to the invention can also be achieved with such playback means.

Ultimately, an extremely comfortable, user-friendly and reliable system for playing back audio information is therefore provided, which system has a very high degree of flexibility with respect to the possibilities for adapting the information which is played back and, on the other hand, ensures an extremely high-quality listening experience.

In this case, it should finally be pointed out again that the method is not restricted to the application of the simultaneous playback of audio and image/video information. It would actually be conceivable to also use the concept according to the invention in the playback solely of audio data. Furthermore, the method could also be used by only a single user in any desired space or outdoors.

1. A method for transmitting and playing back acoustic information, preferably in a multimedia application, comprising the following steps of:
a) providing acoustic data which are in digital form and comprise a first data part and a second data part, wherein the first data part does not contain any speech information and the second data part contains speech information;
b) transmitting the first data part to first audio playback means and outputting acoustic signals corresponding to the first data part by means of the first audio playback means;
c) transmitting the second data part to second audio playback means and outputting acoustic signals corresponding to the second data part by means of the second audio playback means;
wherein the second audio playback means are positioned differently with respect to a user assigned to them than the first audio playback means in particular in the immediate vicinity of the user, and are designed in such a manner that
the user can hear the acoustic signals emitted by the first audio playback means, and
the acoustic signals emitted by the second audio playback means can be heard substantially only by the user.

2. The method as claimed in claim 1,
wherein
in that there are a plurality of users which are each individually assigned second audio playback means, wherein
the acoustic signals emitted by the first audio playback means can be jointly heard by all users, and
the acoustic signals emitted by the second audio playback means can be heard substantially only by the respective user this second audio playback means.

3. The method as claimed in claim 1,
wherein
in that the second data part transmitted to the second audio playback means is individually selected by the user, in particular in such a manner that the speech information contained in the second data part is available in a language selected by the user.

4. The method as claimed in 1,
wherein
in that the second data part is modified in order to take into account the space or location where the acoustic information is played back, wherein, if there are a plurality of users, the second data part is preferably modified in the same manner for all users.

5. The method as claimed in claim 4,
wherein
in that the second data part is modified by using a binaural filter, wherein parameters of the filter are preferably determined on the basis of previously performed test measurements.

6. The method as claimed in claim
wherein
in that the second data part is centrally modified before the second data part is transmitted.

7. The method as claimed in claim 1,
wherein
in that the second data part is individually modified before the acoustic signals are played back by the second audio playback means in order to take into account the position of the second audio playback means in relation to the first audio playback means and the orientation of the second audio playback means.

8. The method as claimed in claim 7,
wherein
in that the modification is carried out by the second audio playback means, wherein the modification relates, in particular, to the consideration of a time delay of the playback.

9. The method as claimed in claim 1,
in that optical information, in particular video information, is played back at the same time as the acoustic information is transmitted and played back.

10. The method as claimed in claim 1,
wherein
in that the second data part is transmitted wirelessly, optionally with the aid of a cellphone coupled to the second audio playback means.

11. A system for transmitting and playing back acoustic information, preferably in a multimedia application, comprising:
a) a storage device for providing acoustic data which are in digital form and comprise a first data part and a second data part, wherein the first data part does not contain any speech information and the second data part contains speech information;
b) means for transmitting the first data part to first audio playback means;
c) first audio playback means for outputting acoustic signals corresponding to the first data part;
d) means for transmitting the second data part to second audio playback means;
e) second audio playback means for outputting acoustic signals corresponding to the second data part;
wherein the second audio playback means are positioned differently with respect to a user assigned to them than the first audio playback means, in particular in the immediate vicinity of the user, and are designed in such a manner that
the user can hear the acoustic signals emitted by the first audio playback means, and
the acoustic signals emitted by the second audio playback means can be heard substantially only by the user.

12. The system as claimed in claim 11,
wherein
in that the first audio playback means are an arrangement of one or more loudspeakers, and
in that the second audio playback means are headphones.

13. The system as claimed in claim 11,
wherein
in that it has a plurality of second audio playback means.

14. The system as claimed in claim 11,
wherein
in that the second data part transmitted to the second audio playback means is individually selected by the user, in particular in such a manner that the speech information contained in the second data part is available in a language selected by the user.

15. The system as claimed in claim 11,
wherein
in that it has additional means for synchronously playing back video data.
